(19) United States
(12) Patent Application Publication
(10) Pub. No.: US 2005/0080731 A1
(43) Pub. Date: Apr. 14, 2005

(54) Apparatus for conducting banking transactions including depositing and withdrawal of cash

(76) Inventor: Agashe Mandar Dnyaneshwar, Pune (IN)

Correspondence Address: MUSERLIAN, LUCAS AND MERCANTI, LLP, 475 PARK AVENUE SOUTH, 15TH FLOOR, NEW YORK, NY, 10016, US

(21) Appl. No.: 10/992,801

(22) Filed: Nov. 19, 2004

(30) Foreign Application Priority Data
Sep. 22, 2003 (IN) 994/MUM/2003

(51) Int. Cl. G06F 17/60

(52) U.S. Cl. 705/39; 705/42

(57) ABSTRACT

The Sarvatra™ system provides an apparatus for conducting banking transactions including depositing and withdrawal of cash by an account holder in a branch of a bank. The system consists of [i] a data center having a “sarvatra” cluster [ii] an operations center for maintaining records of all operations; [iii] POS terminals; [iv] account data storage means; [v] Network Interfaces linking: the data center to the operation center, the POS terminals to the data center and the said account data storage means to the data center via a network; [vi] a sarvatra card on which is recordable account information of an account holder; [vii] an electronic financial transaction switch adapted to send and receive information from the POS terminals and send and receive information from said account data storage means in the branches and further adapted to selectively route transactions to and from bank branches.

This invention relates to an apparatus for conducting banking transactions including depositing and withdrawal of cash.

Banking transactions are conducted in two basic ways. [1] A customer walks into his bank and manually performs transactions with a bank officer a cashier or otherwise; or [2] ATMs are provided where a customer can perform banking operations at locations generally remote from his actual branch.

Both methods have their limitations. Although ATMs are becoming increasingly popular, they are very expensive for the bank and small bank cannot utilize the ATM system.

The apparatus and method of this invention hereinafter called the “sarvatra™” system is suitable for small banks having limited resources and many branches to utilize a system where a customer can conduct limited banking operations including depositing and withdrawal of cash at any of the branches of the bank other than the branch where the customer has an account.

According to this invention there is provided an apparatus for conducting banking transactions including depositing and withdrawal of cash by an account holder in a branch of a bank from any of the other bank branches or other authorized outlets each of said branches having a unique bank identification number; said apparatus consisting of
[i] a data center having a “sarvatra” cluster as herein defined and data storage means for storage of data;
[ii] an operations center for maintaining operations;
[iii] POS terminals provided at all the said branches and other authorized outlets;
[iv] account data storage means for storing remotely operable client account information and record at all the said branches and other authorized outlets;
[v] Network Interfaces linking: the data center to the operation center, the POS terminals to the data center and the said account data storage means to the data center via a network such as PSTN Dialup, GSM, Ethernet and the like for accessing the accounts of any account holder in any branch of a bank;
[vi] a sarvatra card as herein defined on which is recordable account information of an account holder, which card is readable by the aid of POS terminals;
[vii] an electronic financial transaction switch provided in the data center adapted to send and receive information from the POS terminals via the linked network and send and receive information from said account data storage means in the branches and further adapted to selectively route transactions to and from bank branches based on the bank identification number and adapted to fetch and store information of all such transactions in the operations center.

In accordance with a preferred embodiment of this invention, the electronic financial switch is adapted to interface with other electronic financial switches of other institutions for inter institution transactions.

Typically, the POS terminals have a serial interface for external devices such as a printer, PIN Pad and the like. In addition, the POS terminals have an Ethernet interface for connecting the POS to a local area network and an interface for connecting the POS to a global system for mobiles to utilize the mobile network.

In accordance with a preferred embodiment of this invention, the data center includes a network access controller comprising a bank of modems for dialup connectivity with the POS terminals and adapted to accept information from the POS terminals and forward to the electronic financial switch.

In accordance with a preferred embodiment of this invention, the data center includes a ‘Sarvatra’ cluster having (i) a host which is a processing means for processing transactions, (ii) a security module adapted to authenticate and generate a customer PIN, encryption means for encrypting all information and POS transactions, and authentication means for authenticating a POS terminal and (iii) a service interface for the electronic financial switch for reading a request from the switch, deciphering said request, forwarding requests to the host for processing and sending processed information to the switch.

In accordance with a preferred embodiment of this invention, the electronic financial switch is adapted to maintain a log of every transaction received along a delivery channel from a POS terminal and store such a log data in the Sarvatra cluster.

In accordance with this invention, the sarvatra cluster includes a interface between the said switch and the said host security module

The invention will now be described with reference to the accompanying drawings, in which

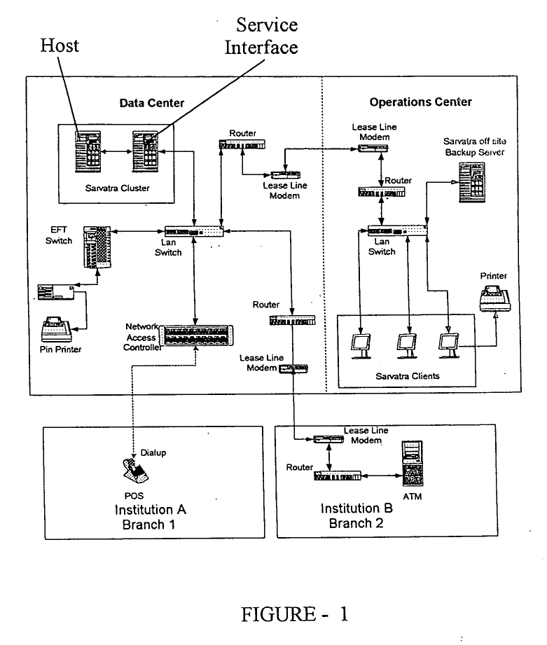

FIG. 1 shows the apparatus of the invention.

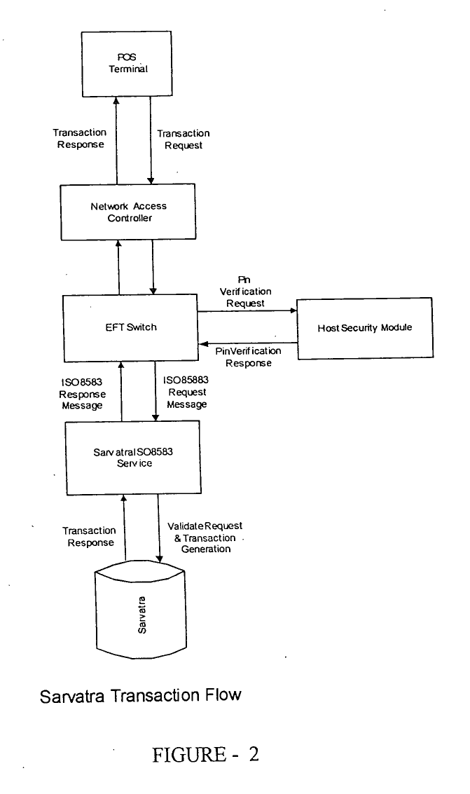

FIG. 2 shows a Sarvatra transaction flow chart;

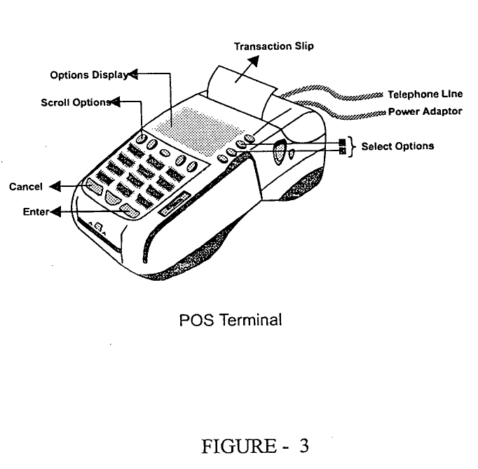

FIG. 3 shows details of a POS terminal;

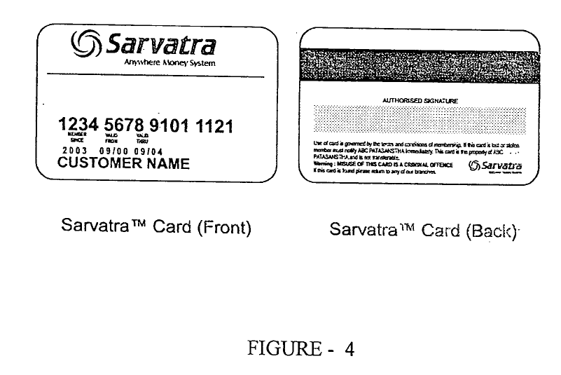

FIG. 4 shows details of a Sarvatra card;

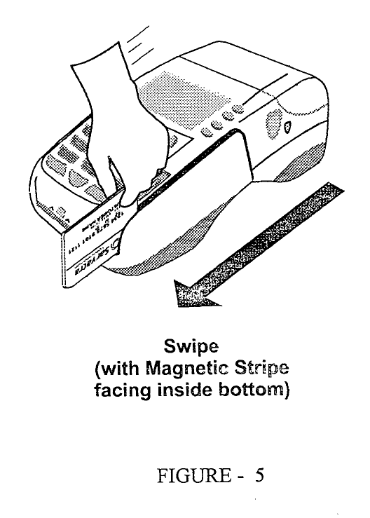

FIG. 5 shows the operation of the POS terminal with the card of FIG. 4;

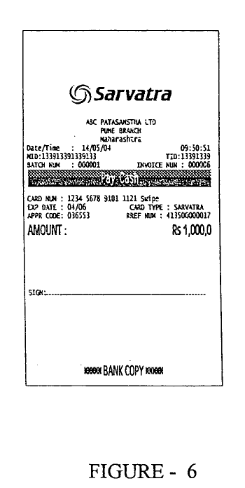

FIG. 6 shows a ‘sarvatra’ transaction slip in accordance with this invention;

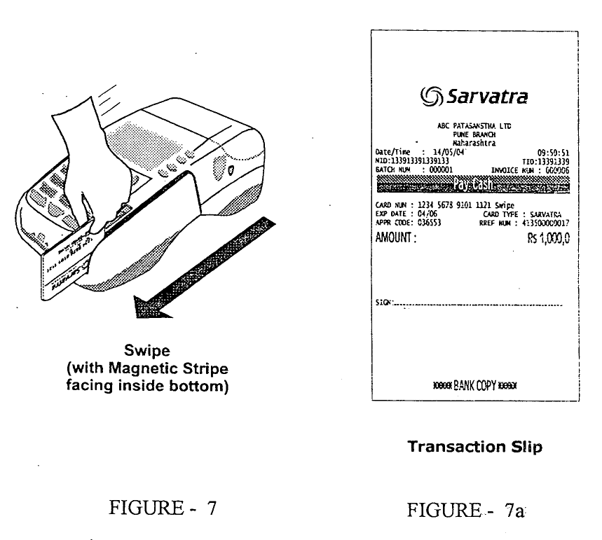

FIGS. 7 and 7a show the operation for a cash withdrawal and the accompanying specimen transaction slip;

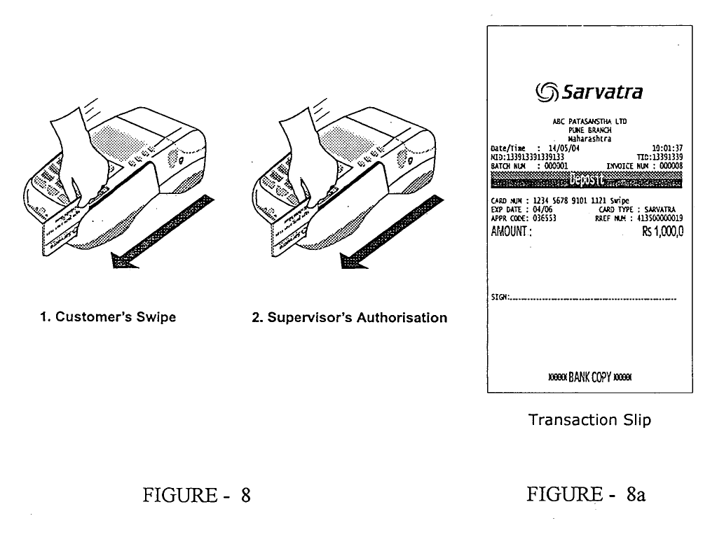

FIGS. 8 and 8a show the operation for a cash deposit and the accompanying specimen transaction slip;

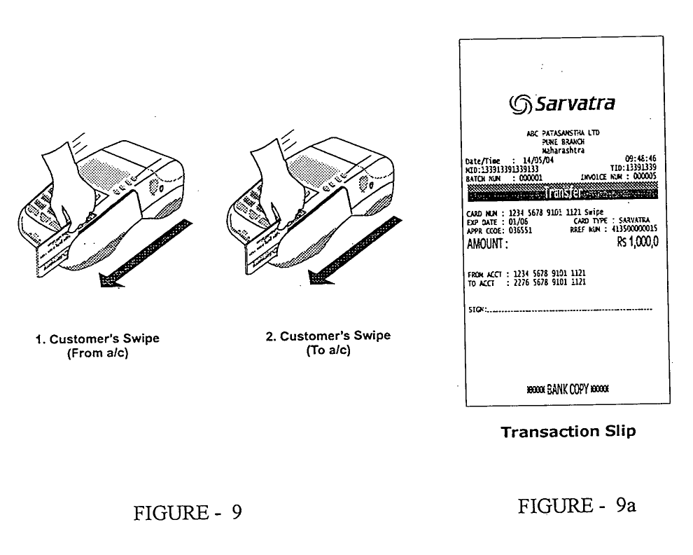

FIGS. 9 and 9a show the operation for a transfer from account to account and the accompanying specimen transaction slip;

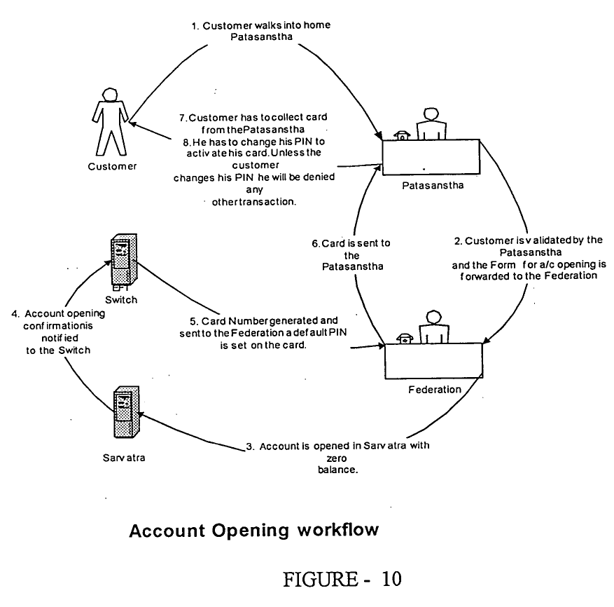

FIG. 10 shows a workflow diagram for account opening transaction in accordance with this invention;

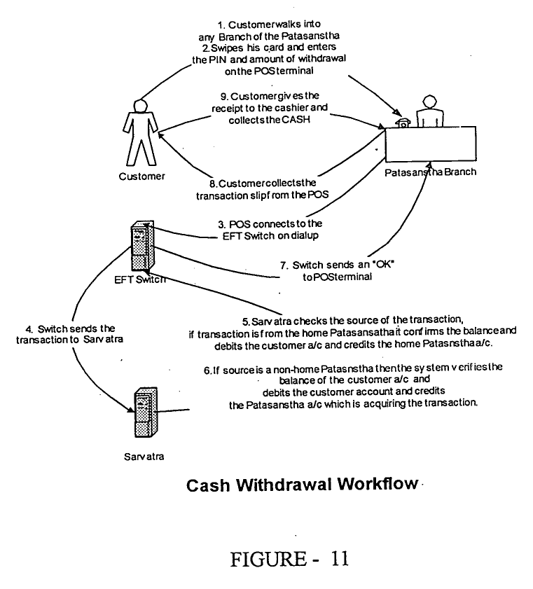

FIG. 11 shows a workflow diagram for cash withdrawal transaction in accordance with this invention;

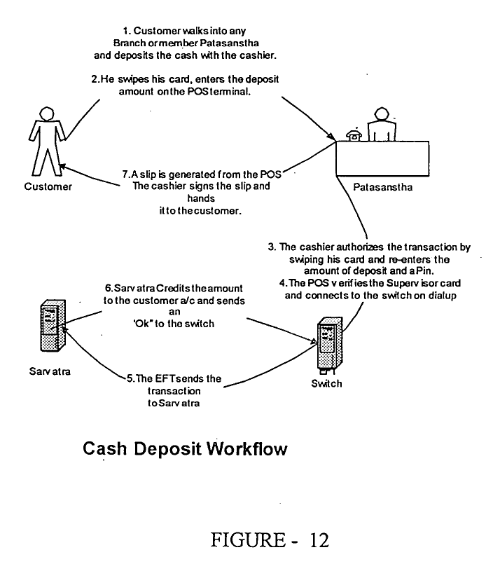

FIG. 12 shows a workflow diagram for cash deposit transaction in accordance with this invention;

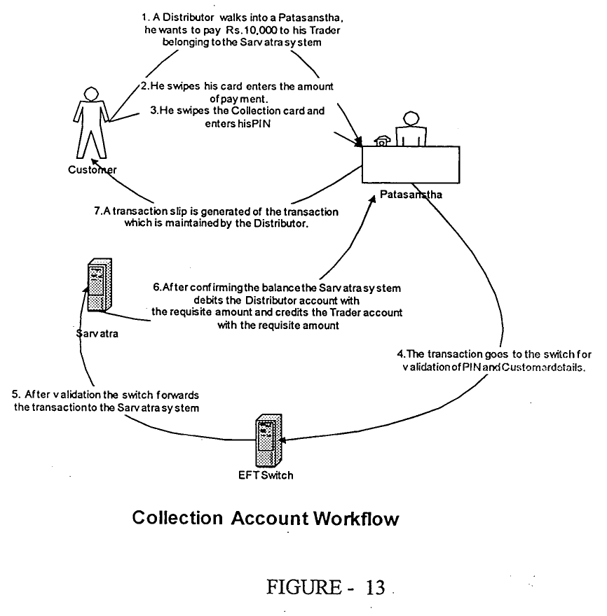

FIG. 13 shows a workflow diagram for collection account transaction in accordance with this invention; and

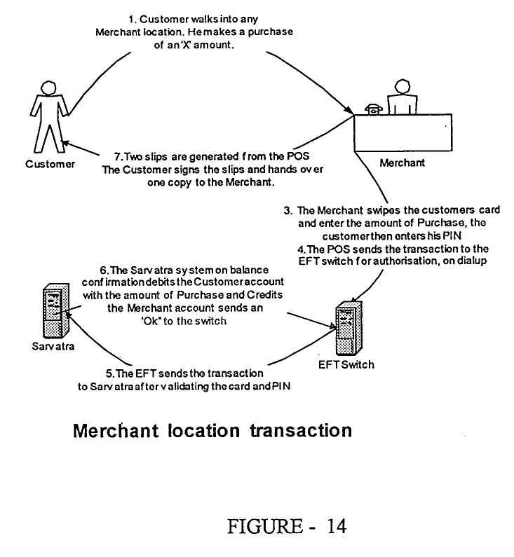

FIG. 14 shows a workflow diagram for merchant location transaction in accordance with this invention.

Referring to the drawings, FIG. 1 shows the apparatus of the invention in which is shown the system architecture of the invention.

The system architecture of the apparatus as shown in FIG. 1 of the accompanying drawings and is self explanatory. Data transmission is achieved between the branch and the data center at a central location using conventional dial up modems of the analog type. This reduces communication costs.

The POS terminal envisaged in accordance with this invention will be interfaced with the customer's branch via

Network Interfaces

PSTN Dialup

GSM

Ethernet

In accordance with this invention the branches of the bank will have to be permanently connected to a data center using any of the aforesaid network interfaces. The POS terminal at the branch will be connected to a data center and eventually the customer's branch via dial up connectivity.

Additional Interfaces Include

Biometric finger print recognition for authorization

Digital Signatures

The main advantages of using the apparatus in accordance with this invention is that the existing infra structure of the bank does not need to be disturbed. The investment of the bank is therefore preserved.

POS (Point of Sale) terminal is shown in FIG. 1 and particularly shown in detail in FIG. 3 and other figures is located in all the subscribing branches of a bank or financial institution.

A point of service [POS] terminal is provided in every branch. A customer can withdraw cash from any of the branches of the bank using a POS terminal during banking hours or an ATM terminal during non banking hours.

The POS terminal is a delivery channel of the sarvatra™ system. The POS terminal has a dial up interface to the Sarvatra™ system. It has a serial interface for external devices like PIN PAD, Printers etc.

An optional Ethernet interface can connect the POS over a local area network (LAN).

The POS can also be enabled with a GSM (global system for mobiles) interface to utilize the mobile networks.

The POS sends messages to the EFT (electronic financial transaction) switch in ISO8583 format.

The various transactions possible from the POS are
Balance Enquiry
Cash Withdrawal
Cash Deposit
Funds Transfer
Debit Sale
Pin Change
Reversals
   Settlement

FIG. 2 shows a block diagram of the working of the invention which is self explanatory. The work flow of the operation is provided showing the movement of the signal from the POS terminal to the Sarvatra host via the network access controller and the EFT switch the Sarvatra service module and the host after verification from the host security module.

The data center of FIG. 1 of the accompanying drawings includes a “sarvatra” cluster which consists of a host which is a processing means having a security module and a service interface

The operations center as seen in FIG. 1 provides the back up server in which all prior transactions are stored and which has a data base of all Sarvatra™ subscribing clients who can then obtain periodic records of all transactions.

A Network Access Controller (NAC)

The Network access controller is a modem bank of SDLC modems that provides dialup connectivity to the POS terminals.

The modem of the NAC can support speeds from 1200 baud to 9600 baud.

The NAC accepts the call from the POS terminal strips the SDLC header and forwards the data to the EFT switch.

One modem port of the NAC can support 40 POS terminals (1:40 is an international standard)

The NAC has a management interface for monitoring and management of the modems.

It has an Ethernet interface which connects to the LAN and is used to interact with the EFT switch.

The Host Security Module (HSM)

The Host security module authenticates and generates a customer PIN.

It uses single DES for encryption

It also generates session keys for encryption of a POS transaction.

A new key can be generated for every session.

The HSM also authenticates a POS terminal during a logon message.

The current HSM is a serial HSM which can authenticate 12 transactions/second.

Electronic financial transaction (EFT) Switch

The electronic financial transaction switch is the heart of the system.

The switch routes transactions from various delivery channels to the correct Bank host based on a bank identification number (BIN).

It maintains information on Customer Cards, Delivery channels, Host systems and can interface with other EFT switches for Inter Institution transactions.

It supports the ISO8583, NCR NDC and Diebold D912 protocols.

It supports delivery channels like POS and ATM's.

Entire customer card management like Card generation, hot carding, card expiry is done by the EFT switch.

The EFT switch accepts a transaction from the delivery channel validates the Customer card number, expiry date verifies if the card is active or hot and then forwards the transaction to the Bank host, else it will return an error message to the delivery channel.

It maintains a log of every transaction that is sent by a delivery channel.

The EFT switch assures transaction completion. It will either give a success or a failure for every transaction that enters the switch.

The service interface in the data center is part of the sarvatra cluster an is in accordance with a preferred embodiment of this invention a Sarvatra™

ISO8583 Service

The Sarvatra™ ISO8583 service is an interface between the EFT switch and the Sarvatra™ Host.

It works as an ISO8583 translation service between the EFT switch and the Sarvatra™ Host.

It reads a request from the EFT switch in ISO8583 format deciphers it and forwards the transaction to the Sarvatra™ Host. Sarvatra™ host processes the transaction and sends a response to the Sarvatra™ ISO8583 service. The Sarvatra™ ISO8583 service reads the response sent by the Sarvatra™ Host and responds to the EFT switch in ISO8583 format.

The Sarvatra™ ISO8583 service in accordance with one embodiment is a Java application and it connects to the Sarvatra™ host over a JDBC (java database connectivity) connection.

The Sarvatra™ ISO8583 service also does logging of every transaction sent by the EFT switch to the Sarvatra™ host. It also maintains a queue in case the Sarvatra™ host is busy.

Sarvatra™ Host Processing Means

Sarvatra™ host can be an Oracle based application with D2k front end. It is a complete core banking application which maintains

Master Information

Institution Master

Customer Master

Product Master

Card Master

Merchant Master

Terminal Master

Service charge

Account restrictions

Holiday maintenance etc

Transaction Processing

Cash Withdrawal

Cash Deposit

Balance Enquiry

Funds transfer

Interest calculation

Transaction fee calculation

Service charge calculation

Maker-Checker Authorization etc.

Daily Activities

Begin of day (BOD)

Account opening

Account closing

Cash Management

Standing instructions

Passbook maintenance

End of Day (EOD)

A typical POS terminal is seen in FIG. 3 of the accompanying drawings.

The POS terminal serves as the primary delivery channel in the Sarvatra™ system.

The POS terminal consists of

Processor

The processor is 32 bit.

Memory

1 MByte of FLASH (optional 2 Mbytes) and 512 Kbytes of SRAM

Display

128×64 pixels LCD with backlighting, supports 8 lines×21 characters, including graphics.

The display enables a user to view the various facilities provided by the Sarvatra™ system. The brightness of the display can be controlled through the built in software.

Magnetic Stripe Reader

The magnetic stripe reader reads 3 tracks of a magnetic stripe card and is integrated in the POS terminal. The reader is high coercive and bidirectional.

Option Keys

The option keys enable a user to choose amongst various options provided by the Sarvatra™ system. The option keys are very user friendly and intuitive. It plays a key role in acceptability of the system. These option keys are called as screen addressable keys. Some of the keys such as the option display, scroll option the cancel key and the enter key are shown in FIG. 3.

Keypad and Pinpad

The keypad is 3*4 numeric keypad plus 8 soft function keys and 4 screen addressable keys.

The keypad and the secure Pinpad is primary source of input for entering a PIN (personal identification number) or any other input required by the system.

It is tamper proof and any physical tampering will erase the master keys of the terminal making it unusable.

Peripheral Ports

Two RS-232 ports support peripherals including PIN pads, check readers and bar code wands. Telecom port supports PSTN dialup. Other interfaces like Ethernet, CDMA, GPRS are also available.

The various connectivity interfaces provide versatility to the Sarvatra™ system.

Thermal Printer

The integrated thermal printer provides graphic printing capabilities. It prints 12.5 Lines per second, 24/32/42 columns and prints out a transaction slip as seen in FIG. 3. The paper is a standard roll paper 58 mm (2.25 in)*25 M. The quiet, fast speed printing and easy paper roll loading mechanism are the USP's of the printer.

Modem

Is connected to the telephone line as seen in FIG. 3. The specs of the modem which is integrated with the POS are as follows

Dial modem: Bell 103/212a, CCITT V.21/V.22/V.22 bis, 300/1200/2400 bps synchronous and Asynchronous.

In accordance with another feature of the invention, the apparatus includes a magnetic stripe card which holds the user information of the customer. The apparatus includes a PIN [personal identification number provided to the customer which will be known only to the customer. Based on these two i.e. the magnetic stripe and the Pin the customer will be able to authenticate every transaction.

The apparatus of the invention supports the following banking transactions:
Cash withdrawal
Balance Enquiry
Mini Statement
Pin Change
Cash Deposit.

It is envisaged that such an account will not be supported by a cheque book but by a swipe card and will enable the account holder to deposit and withdraw cash and earn interest similar to the conventional banking system. The bank will be able in accordance with the embodiment of this invention impose a ceiling on a daily withdrawal limit

Figure shows details of a Sarvatra™ card in accordance with a preferred embodiment of this invention.

The Sarvatra™ card is a plastic card with a magnetic stripe. It follows the ISO 7810 standard for physical characteristics of the Card.

The specifications of the card are as follows

Size: 86×54 mm

Thickness: 0.76 mm

Magnetic Stripe:

Supported magnetic stripes are Lo coercive and High coercive. The high coercive stripe is 2500 to 4000 Oe and low coercive stripe is of 300 Oe.

Track Encoding:

Encoding Track 2, Recording Density (bits per inch) 75 BPI, Character Configuration 5 bits per character. The track 2 can accommodate 40 characters.

The card is personalized with the card number which is a 16 digit number, the name of the customer, the date the card is issued and the expiry of the card.

The card contains a signature panel located at the back of the card.

The card can also have a photograph of the customer.

FIG. 5 shows the operation of the POS terminal with the card of FIG. 4; To identify a user on the Sarvatra™ system, the system prompts a user to Swipe his Magnetic stripe card. FIG. 5 illustrates a swipe. The card has to be swiped with the magnetic stripe at the bottom and facing inside.

FIG. 6 shows a ‘sarvatra’™ transaction slip in accordance with this invention;

A transaction slip is generated after a transaction approval.

The transaction slip is printed in duplicate, one as the institution copy and another for the customer.

The transaction slip contains the following details
Transaction type

The transaction type is printed in Bold in the center of the transaction slip
Institution details

Institution details like the name and address of the institution are printed at the top of the transaction slip
Terminal ID

The terminal ID is an identification number which uniquely identifies a POS terminal in the Sarvatra™ network.
Date & Time

The transaction slip notifies the date and time at which a transaction was performed.
Card Number

The slip prints the card number of the customer which enables to identify the user who performed the transaction.
Expiry Date

The expiry date field displays the expiry date of the card.
Transaction Method

This notifies whether a transaction was performed with a card swipe or by manual entry of the card number.
Signature

A field for customer signature is maintained at the bottom of the transaction slip which a customer has to sign after a transaction is approved.
Transaction slip type

A transaction slip is printed in duplicate and the transaction slip mentions the type whether an Institution copy or a customer copy. This is printed at the bottom of the slip.

FIG. 7 and 7a show the operation for a cash withdrawal and the accompanying specimen transaction slip;

Cash Withdrawal

The POS terminal will be kept under supervision.

A customer walks up to the POS terminal.

He selects the Cash Withdrawal Option using the option keys on the POS terminal

He is prompted to swipe his card as seen in FIG. 7 of the drawings

He then enters the amount of withdrawal

He then enters the PIN

The POS terminal dials up the Sarvatra™ system, the balance of the customer is checked and transaction is approved if the requisite balance is available

A transaction slip is generated in duplicate from the terminal of the approved transaction.

The customer signs both the transaction slips (institution copy, customer copy) and hands it to the cashier

The cashier hands over the cash to the customer along with the customer copy of the transaction slip. A sample of the transaction slip is shown in FIG. 7a of the accompanying drawings.

FIG. 8 and 8a show the operation for a cash deposit and the accompanying specimen transaction slip;

Cash Deposit

A customer walks in to the branch, he fills in a cash deposit slip and hands over the cash to the cashier, the cashier counts the cash and confirms the amount.

The customer selects the Cash Deposit option from the POS terminal

He is prompted to swipe his card. This is represented by 1 of FIG. 8.

He enters the amount of deposit

He then enters the PIN

The POS then prompts for a Supervisor authorization.

This is done by swiping a supervisor card which is present with the cashier represented by 2 of FIG. 8

The cashier enters the supervisor PIN and re-enters the amount of Deposit.

If the amount entered by the customer and the cashier mismatches the transaction is terminated.

The POS then dials up and confirms the customer as well as Supervisor PIN and on approval credits the customer account with the requisite amount instantly.

This method of double swiping for authorization is the unique feature of the system. The transaction results in a transaction slip represented in FIG. 8a of the accompanying drawings.

FIG. 9 and 9a show the operation for a transfer from account to account and the accompanying specimen transaction slip;

Transfer From Account—To Account

A customer walks up to a POS terminal located in the branch

He selects a Transfer transaction from the POS menu.

He is prompted to swipe his card. This is represented by 1 of FIG. 9.

He then enters the amount of transfer and his PIN

He is then prompted to either swipe the card of the “To account” or manually enter the card number of the “To account” This is represented by 2 of FIG. 9.

The POS then dials up the Sarvatra™ system and after confirming the balance and the customer PIN transfers the requisite amount from the “From account” to the “To account”

A transaction slip is generated on approval which contains the “From account” and the “To account” card numbers.

A sample of the transaction slip is show in FIG. 9a

FIG. 10 shows a workflow diagram for account opening transaction in a financial institution (patasanstha) accordance with this invention;

The account opening workflow is as follows

The customer walks into a branch referred to in the diagram as a “Patasanstha” and fills up an account opening form and submits it to the concerned authority

The Patasanstha collects all such account opening requests validates the customer and sends it to the Federation for account opening.

The Federation opens the customer account under the particular Patasanstha A card is generated for the customer and a default PIN is assigned to the customer

The customer card and the default PIN is couriered to the Patasanstha

The customer account is opened with zero balance.

The customer collects the card from his local Patasanstha branch.

The first transaction allowed on the card is PIN change transaction. The customer account is activated only after changing his default PIN

Once the customer changes his PIN and selects a new PIN know only to him the account is activated

Now the customer can do a deposit to his account which will be immediately credited to his account.

FIG. 11 shows a workflow diagram for cash withdrawal transaction in accordance with this invention from a financial institution;

In case of Cash Withdrawal transactions the inter Patasanstha reconciliation is done online. The transactions are as follows

Customer of Patasanstha ‘A’ goes to a member Patasanstha ‘B’ and withdraws an amount of Rs.1000

Balances of the respective accounts before transaction are as follows

| | |
|---|---|
| Customer Account | Rs. 10,000 |
| Patasanstha ‘B’ | Rs.200,000 |

When the customer withdraws Rs.1000 the balances of his account is verified. After confirmation of balances the following transactions take place

| | |
|---|---|
| Customer Account | Dr 1000 (−T)* |
| Patasanstha ‘B’ account | Cr 1000 (−T)* |

The modified balances of the respective accounts after transaction are as follows

| | |
|---|---|
| Customer Account | Rs. 9,000 (−T)* |
| Patasanstha ‘B’ account | Rs.201,000 |

*Transaction fee

A STRIKING feature of the system is that all these transactions are online and no end of day reconciliation is required. The transaction fees are also credited online to the respective parties.

FIG. 12 shows a workflow diagram for cash deposit transaction in accordance with this invention;

In case of cash deposit the amount of deposit is immediately credited to the customer account.

Customer of Patasanstha ‘A’ goes to a member Patasanstha ‘B’ and deposits an amount of Rs.1000. He hands over the deposit amount with the cashier which the cashier verifies.

Balances of the respective accounts before transaction are as follows

| | |
|---|---|
| Customer Account | Rs. 10,000 |
| Patasanstha ‘B’ | Rs.200,000 |

The customer selects a cash deposit transaction on the POS, swipes his card and enters the amount of deposit and his PIN. The cashier swipes his supervisor card and re-enters the amount of deposit. The transaction is authorized after both the cards and PIN is authenticated and the following transactions take place

| | |
|---|---|
| Customer Account | Cr 1000 (−T)* |
| Patasanstha ‘B’ account | Dr 1000 (−T)* |

The modified balances of the respective accounts after transaction are as follows

| | |
|---|---|
| Customer Account | Rs.11,000 (−T)* |

| | |
|---|---|
| Patasanstha ‘B’ account | Rs.199,000 (−T)* |

*T transaction fee

A feature of the system in accordance with this invention is that the customer can utilize the cash deposited the very next instance of his deposit transaction again the transaction fees are credited to the respective parties online.

FIG. 13 shows a workflow diagram for collection account transaction in accordance with this invention; and

This is a Business to Business transaction. Wherein a Trader can open a collection account with a Patasanstha and distribute collection cards to his distributors. These collection cards will be used by the distributors to pay to the Trader.

A trader ‘A’ opens a collection account with Patasanstha ‘A’ and gets 5 collection cards which he distributes to his Traders. He informs them that any payments to be made to him will be made using the Collection card.

Now when a distributor ‘A’ has to pay Rs.200,000 to the Trader he will do the following.

He will go to a member Patasanstha ‘B’, Swipe his card and enter the amount he wants to transfer to his Trader ‘A’. He will then swipe the collection card of the Trader ‘A’ and enter his Pin.

The balances of the respective accounts before transfer will be as follows

| | |
|---|---|
| Distributor account | Rs.300,000 |
| Trader account | Rs.500,000 |

The balances of the Distributor account will be verified and the following transactions will take place

| | |
|---|---|
| Distributor account | Dr 200,000 (−T)* |
| Traders account | Cr 200,000 (−T)* |

The balances of the respective accounts after transaction

| | |
|---|---|
| Distributor account | Rs.100,000 (−T)* |
| Trader account | Rs.700,000 (−T)* |

*T transaction fee

The feature of the system is that it allows instant collection facility to the Traders.

FIG. 14 shows a workflow diagram for merchant location transaction in accordance with this invention.

This transaction enables a customer to pay a Merchant using the Sarvatra Card. In this transaction the customer account is debited and the Merchant account is credited instantly with Transaction fee debited and credited to respective parties.

A Customer ‘A’ goes to a Merchant location to buy goods. He buys goods worth Rs.1000.

The balances of respective accounts before transaction are as follows

| | |
|---|---|
| Customers account | Rs. 10,000 |
| Merchants account | Rs. 200,000 |

While paying the Merchant he hands over the card to the Merchant, the merchant swipes the card enters the amount of transaction and hands over the POS to the customer.

The customer enters his Pin and upon confirmation of balance, the following transactions take place

| | |
|---|---|
| Customer account | Dr 1000 (−T)* |
| Merchants account | Cr 1000 (−T)* |

The balances of respective accounts after transaction

| | |
|---|---|
| Customer account | Dr 9000 (−T)* |
| Merchants account | Cr 201,000 (−T)* |

*T transaction fee

The feature of the system is that the Merchant fees are settled online.

The Sarvatra™ system in accordance with this invention is therefore designed to enable financial transactions over Point of Sale (POS) terminals. The system utilizes the POS terminals in a unique way to enable the following transactions namely
Cash Withdrawal
Cash Deposit
Funds transfer from account—to account
Balance Inquiry
Pin Change

The main features of the system are therefore as follows
Transactions are online and instant
Reconciliation between institutions is online.
Online authorization required for certain transactions is available.
The system is reliable and requires low infrastructure at the client end.
The system is built on industry standard infrastructure and the ISO8583 protocol.

Although the invention and particular the system and the apparatus, has been described in terms of particular embodiments and applications, one of ordinary skill in the art, in light of this teaching, can generate additional embodiments and modifications without departing from the spirit of or exceeding the scope of the invention. Accordingly, it is to be understood that the descriptions herein are proffered by way of example to facilitate comprehension of the invention and should not be construed to limit the scope thereof

1. An apparatus for conducting banking transactions including depositing and withdrawal of cash by an account holder in a branch of a bank from any of the other bank branches or other authorized outlets each of said branches having a unique bank identification number; said apparatus consisting of
[i] a data center having a “sarvatra” cluster as herein defined and data storage means for storage of data;
[ii] an operations center for maintaining records of all transactions;
[iii] POS terminals provided at all the said branches and other authorized outlets;
[iv] account data storage means for storing remotely operable client account information and record at all the said branches and other authorized outlets;
[v] Network Interfaces linking: the data center to the operation center, the POS terminals to the data center and the said account data storage means to the data center via a network such as PSTN Dialup, GSM, Ethernet and the like for accessing the accounts of any account holder in any branch of a bank;
[vi] a card on which is recordable account information of an account holder, which card
is readable by the aid POS terminals;
[vii] an electronic financial transaction switch provided in the data center adapted to send and receive information from the POS terminals via the linked network and send and receive information from said account data storage means in the branches and further adapted to selectively route transactions to and from bank branches based on the bank identification number and adapted to fetch and store information of all such transactions in the operations center.

2. An apparatus for conducting banking transactions as claimed in claim 1, in which electronic financial switch is adapted to interface with other electronic financial switches of other institutions for inter institution transactions.

3. An apparatus for conducting banking transactions as claimed in claim 1, in which the POS terminals have a serial interface for external devices such as a printer, PIN Pad and the like.

4. An apparatus for conducting banking transactions as claimed in claim 1, in which the POS terminals have an Ethernet interface for connecting the POS to a local area network.

5. An apparatus for conducting banking transactions as claimed in claim 1, in which the POS terminals have an interface for connecting the POS to a global system for mobiles to utilize the mobile network.

6. An apparatus for conducting banking transactions as claimed in claim 1, in which the data center includes a network access controller comprising a bank of modems for dialup connectivity with the POS terminals and adapted to accept information from the POS terminals and forward to the electronic financial switch.

7. An apparatus for conducting banking transactions as claimed in claim 1, in which the data center includes the data center includes a ‘Sarvatra’ cluster having (i) a host for processing transactions, (ii) a security module adapted to authenticate and generate a customer PIN, encryption means for encrypting all information and POS transactions, and authentication means for authenticating a POS terminal and (iii) an interface for the electronic financial switch for reading a request from the switch, deciphering said request, forwarding requests to the host for processing and sending processed information to the switch.

8. An apparatus for conducting banking transactions as claimed in claim 7, in which the electronic financial switch is adapted to maintain a log of every transaction received along a delivery channel from a POS terminal and store such a log data in the operations center.

9. An apparatus for conducting banking transactions as claimed in claim 7, in which the said interface in the sarvatra™ cluster is an ISO 08583 interface adapted to read requests from the electronic financial switch in the ISO8583 format, decipher it and forward it to the host for processing.

10. An apparatus for conducting banking transactions as claimed in claim 7, in which the said interface in the sarvatra™ cluster is adapted to maintain a queue in case the host is busy.
